(19) United States
(12) Patent Application Publication
(10) Pub. No.: US 2006/0178951 A1
(43) Pub. Date: Aug. 10, 2006

(54) Network based food ordering system

(76) Inventor: Richard E. Rund III, Rochester, NY (US)

Correspondence Address: JAECKLE FLEISCHMANN & MUGEL, LLP, 190 Linden Oaks, ROCHESTER, NY, 14625-2812, US

(21) Appl. No.: 11/243,801

(22) Filed: Oct. 5, 2005

Related U.S. Application Data
(60) Provisional application No. 60/616,039, filed on Oct. 5, 2004.

(51) Int. Cl. G07F 7/00

(52) U.S. Cl. 705/27

(57) ABSTRACT

A network based food ordering system provides for customer requests in food preparation, notification of food availability dates and times which can vary for a specific calendar day, a record of past customer orders which is available to a registered customer, email notification of each order to the customer, and confirmation of the order by the customer by means other then using the food providers web site.

### CROSS REFERENCE TO RELATED APPLICATIONS

This application claims the benefit of U.S. Provisional Application No. 60/616,039 filed Oct. 5, 2004, the entire disclosure of which is incorporated herein by reference.

### TECHNICAL FIELD

The present invention relates to food ordering, and more particularly, to food ordering over a network such as the internet.

### BACKGROUND OF THE INVENTION

Providers of prepared food, such as caterers, must interface with customers to receive the customer's orders, and, similarly, the customer must interface with the food providers to place their orders. In the past usually a customer would travel to a caterers location or call the caterer and select the food to be provided in a dialog between the customer and an employee or owner of the catering service. When taking an order from a customer, the caterer generally writes the order on an order intake form. The data hand written on the form is subsequently transferred to other forms, one form for the kitchen staff preparing the order, another form for the person responsible for ordering the inventory to fulfill the order, just to name a couple examples. The system of copying data from an order intake form to other forms results in many errors, wasted time and money and ultimately, in customer dissatisfaction.

While there has been software in the prior art to help caterers manage kitchens and inventory, such as software offered at www.crunchtime.com, www.catermate.com, www.caterprosoftware.com, www.cateredgesoftware.com and www.caterxpert.com, none of these systems offer an automated method of taking customer orders.

Recently, some alternative web based ordering systems, such as www.quickdine.com have become available to food providers, but these systems are designed for restaurant delivery services, not for caterers, or even restaurants, and have limited capabilities. For example, food providers have no control over the site or the ability to customize the site for their specific needs. Further, none of the prior art systems allow customers the ability to order ready-to-eat food for delivery or pick-up at a future date. Further, personalization of a food product, such as appearance and other variations which are available to walk-in customers, are not possible with current web based systems. In addition, other operating parameters, such as the time of the day when food can be ready for pickup that varies depending on the day of the week, changes to orders previously made, and multiple contacts between the food provider and the customer to lessen the number of errors made in placing orders, are not available in prior art systems.

Therefore, what is needed in the art is a network based food ordering system which allows a customer the ability to order prepared food for delivery or pick-up at a future date and flexibility in the ordering process, and minimizes errors in the ordering process with a minimum of employee participation by the food provider.

### SUMMARY OF THE INVENTION

A network based food ordering system that gives customers the ability to order prepared food for delivery or pick up on a future date is described. Embodiments of the invention allow flexibility in the ordering process and minimize errors in the ordering process with a minimum of employee participation by the food provider.

A first embodiment of the invention comprises a method for catering comprising: displaying a web page on a client computer, the web page offering a plurality of prepared food selections; and receiving input from the client indicating at least on food selection and a future date for desired pick up or delivery of the food selection. Further embodiments can comprise: displaying a web page offering a plurality of future dates on which the food selection can be delivered to or picked up by the client; receiving a second input from the client indicating a second food selection and a second future date for desired delivery or pick up of the food selection; displaying a calendar with at least two sets of distinguishable dates, a first set of dates on which the client is able to receive via delivery or pick up any of the plurality of prepared food selections and a second set of dates on which the client is able to receive via delivery or pick up a subset of the plurality of prepared food selections; displaying a previously placed order; sending an e-mail to the client confirming the input received from the client; receiving input from the client indicating that the client would like to repeat a previously placed order; and/or giving the client an incentive to make future orders by offering an automatically generated electronic coupon the value of which is at least partially based on a client's previous order.

The web page can be customized for a particular caterer and a portion of the input from the client can be automatically placed on a report.

In other embodiments of the invention, a web based prepared food provider site for processing a food order comprises: a page with a first plurality of links for selecting one of a plurality of food items, each link associated with a food item; an area for selecting the quantity of the food item, wherein when one of the food items is selected, it becomes an ordered food item; an order summary page produced when one of the links associated with a food item is activated; said order summary page showing the ordered food item, quantity and price for the ordered food item, the order summary page additionally having a link for processing the food order; an order processing page appearing when the link for processing the food order is activated, the order processing page containing an area for inputting a date for providing the ordered food item; and a payment page for selecting payment options.

Further embodiments can comprise a calendar with at least two sets of distinguishable dates, a first set of dates on which any of the food items can be provided and a second set of dates on which a subset of the food items can be provided; a page displaying previously ordered food items; a page for registered users of the site to log in; and/or an automatically generated electronic coupon, the value of which is at least partially based on a previous order. The site can be customized for a particular caterer.

In other embodiments, a web based food provider site is provided for processing a food order having a home page with a first plurality of link icons representing food categories for selecting one of the first plurality of link icons. The site shows a second plurality of subcategories when one of the first plurality of link icons is selected, each of said subcategories having one or more separate food item identifiers. Each of the food item identifiers has an area for selecting the quantity of the food item, an area for text entry, and a link icon for selecting the food item. An order summary page is provided when the link icon for selecting the food item is activated, the order summary page shows the food items, quantities and prices for the food items that have been selected. A link icon for continuing with the food order brings up an order processing page, the order processing page containing a calendar for selecting a date of providing the food order by the food provider wherein some dates in the calendar are graphically distinguishable from other dates in said calendar to indicate dates with certain restrictions for providing said food order, said calendar having at least three sets of graphically distinguishable dates. A payment page is provided for selecting payment options after the date has been selected.

### BRIEF DESCRIPTION OF THE DRAWINGS

The above-mentioned and other features and advantages of this invention, and the manner of attaining them, will become appreciated and be more readily understood by reference to the following detailed description in conjunction with the accompanying drawings, wherein:

FIG. 1 is a representation of a home page of a network based food provider's web site according to the present invention;

FIG. 2 is a representation of a single food category list page on the food provider's site;

FIG. 3 is a representation of an updated page shown in FIG. 2;

FIG. 4 is a representation of the first step page in the food ordering check out procedure;

FIG. 5 is a representation of the second step page in the food ordering check out procedure;

FIG. 6 is FIG. 5 after a date for the food provider to have the order ready has been selected;

FIG. 7 is FIG. 6 after additional information on the FIG. 6 page has been entered;

FIG. 8 is a representation of the third step page in the food ordering check out procedure;

FIG. 9 is FIG. 8 with a gratuity box added;

FIG. 10 is a representation of the fourth step page in the food ordering check out procedure;

FIG. 11 is a representation of the summarization page of the food order;

FIG. 12 is a representation of an invoice printed for the order;

FIG. 13 is a representation of an email sent to the customer after the order is completed at the web site;

FIG. 14 is a representation of the web page acknowledgement of the customer's confirmation of the order;

FIG. 15 is a representation of the categories of information available to a customer while at the food provider's site;

FIG. 16 is a representation of a listing of the customer's orders;

FIG. 17 is a representation of a calendar showing the customer's orders and the status of each order;

FIG. 18 is a representation of an order summary for an unconfirmed order pulled up by the customer selecting a specific order shown in FIG. 17;

FIG. 19 is a representation of an update/request form for a completed order which can be used by the customer;

FIG. 20 is a representation of an order summary for a confirmed order pulled up by the customer selecting a specific order shown in FIG. 17;

FIG. 21 is a representation of a points redemption page on the web site;

FIG. 22 is a representation of a coupon generated after points have been redeemed; and

FIG. 23 is a representation of an email notification of the existance of the coupon of FIG. 22.

It will be appreciated that for purposes of clarity, and where deemed appropriate, reference numerals have been repeated in the figures to indicate corresponding features.

### DESCRIPTION

In the following detailed description of the preferred embodiments, reference is made to the accompanying drawings which form a part hereof, and in which are shown by way of illustration specific embodiments in which the invention may be practiced. It is to be understood that other embodiments may be utilized and changes may be made without departing from the scope of the present invention.

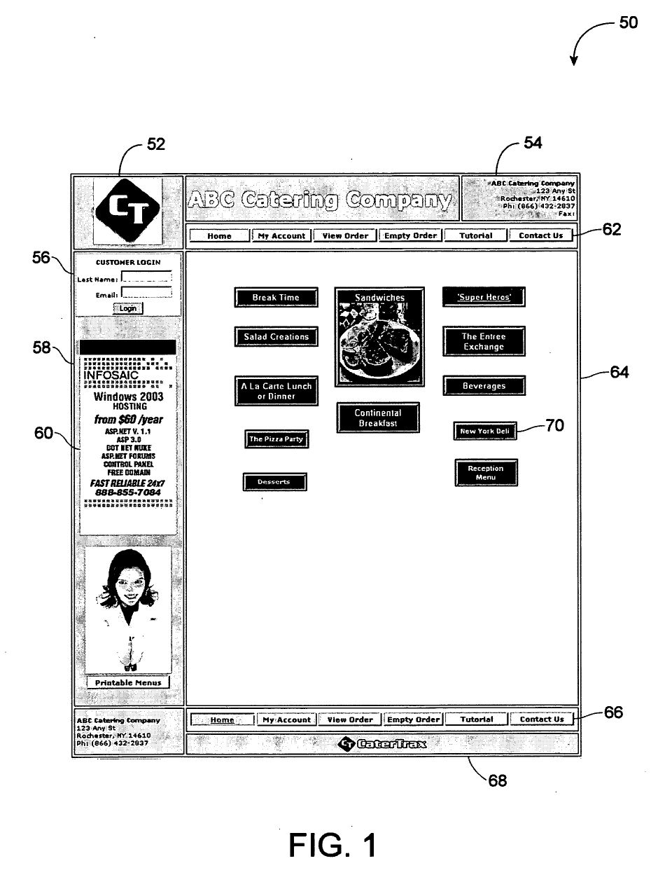

Referring to FIG. 1, a network based food ordering system opening page 50 contains a logo area 52 in the upper left corner of the page, a food providers full name and contact information area 54 across the remainder of the top part of the page, a customer login area 56 below the logo area 52, and a column 58 under the client sign-in area 56 for miscellaneous items which could include an advertisement 60 for example. Directly below the food providers name and contact information 54 is a button row 62 containing a series of buttons for the customer to use to switch to other pages on the web site as described in more detail below.

Below the button row 62 is the food display area 64 containing link icons showing various categories of food available to order. Below the food display area 64 is a second button row 66 with the same buttons that are in button row 62. Finally, below the button row 66 is the software service provider's name 68.

In operation, a customer picks a first food category, such as “New York Deli”, by clicking on the “New York Deli” link icon 70. A returning customer can also login using the customer login area 56 prior to picking the first food category.

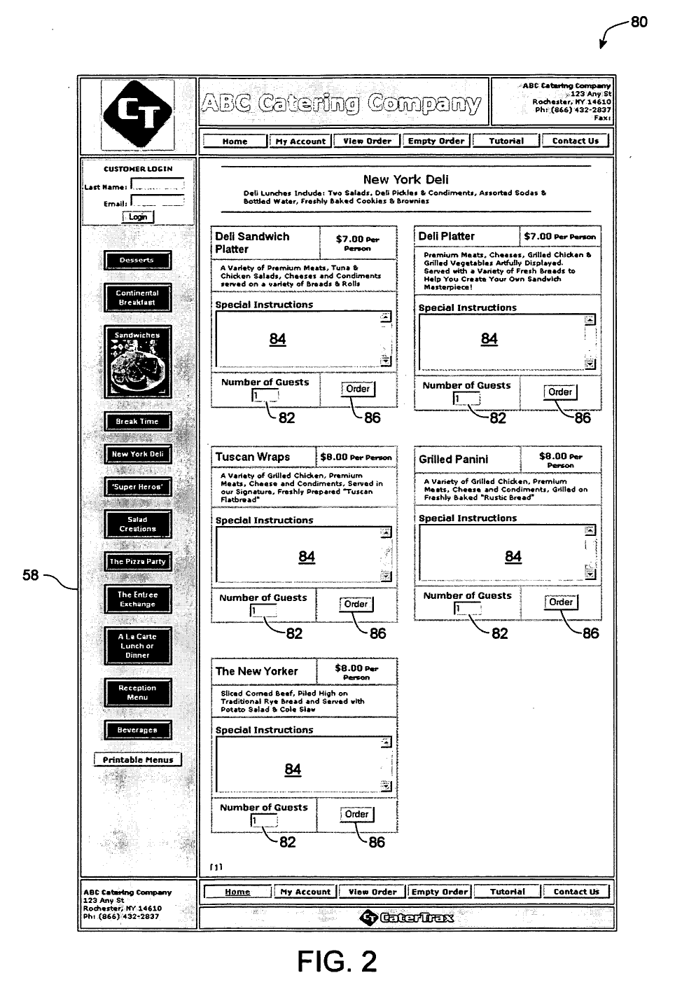

FIG. 2 depicts the “New York Deli” subcategory page 80 which appears after the customer clicks on the “New York Deli” icon 70. Column 58 of FIG. 1 has changed in FIG. 2 to list the food categories shown in display area 64 is FIG. 1. Also, the length of the page has increased to accommodate all of the subcategories of the “New York Deli” category. On the page of FIG. 2 the customer picks one subcategory by entering the number of guests in a box 82 for each subcategory and any special instructions in an area 84. While not shown in FIG. 2, each of the subcategories could have a list of options such as bread type to choose from for each sandwich. The customer then clicks on the “order” button 86 to bring up the next page.

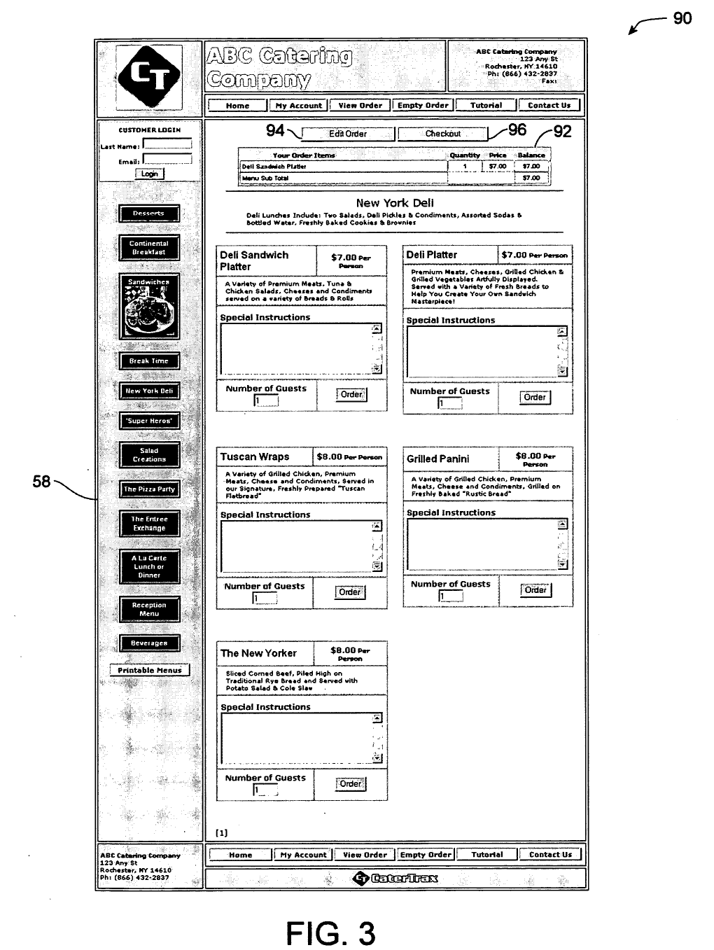

FIG. 3 shows the next page 90 which shows the food items selected on page 80 in a box 92 above the subcategory items. The customer can then select additional sandwiches in this subgroup as described above, can edit the food items already selected by clicking on the “edit order” button 94, can switch to a different food category by clicking on the appropriate icon in the left column 58, or can proceed to checkout by clicking on the “checkout” button 96.

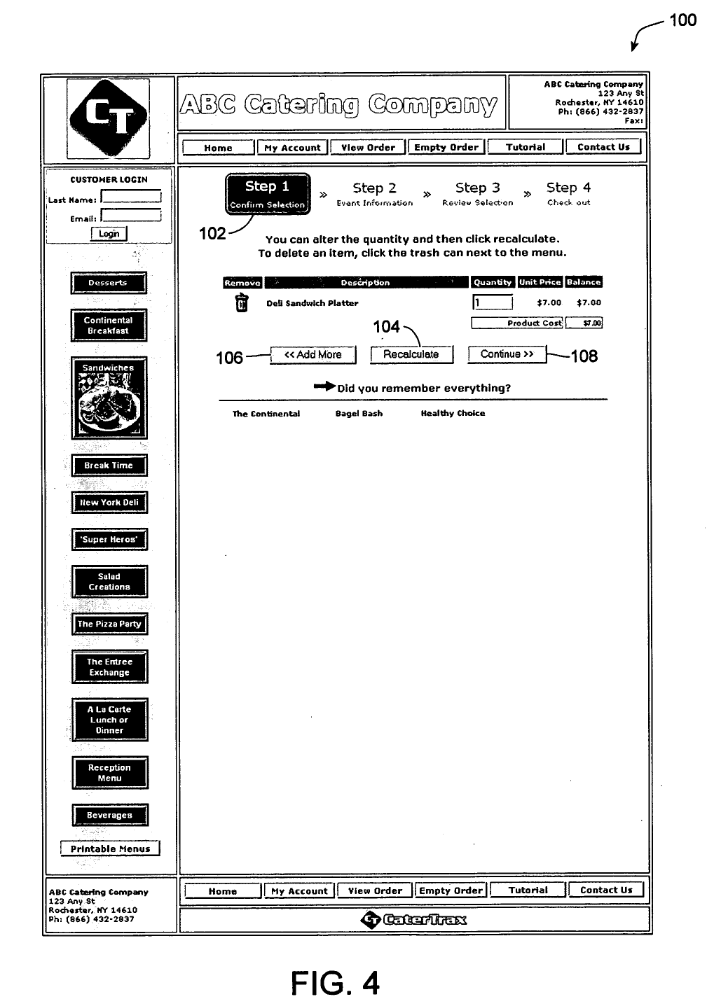

FIG. 4 shows the page 100 which appears after the customer clicks on the “checkout” button in FIG. 3. Page 100 starts a four step order completion process, the first of which, indicated by the “Step 1” icon 102, lists the complete order showing the quantities of each item and the cost for each item, both individually and for the quantity selected, and the total cost for all items. The customer can then edit the order on that page by modifying the quantity of an item or by deleting an item altogether. After editing or deleting, the customer would then click the “recalculate” button 104 to have the costs recalculated. The customer can choose to add additional items by clicking the “<<Add More” button 106, or to continue to the second step in the order completion process by clicking on the “Continue>>” button 108.

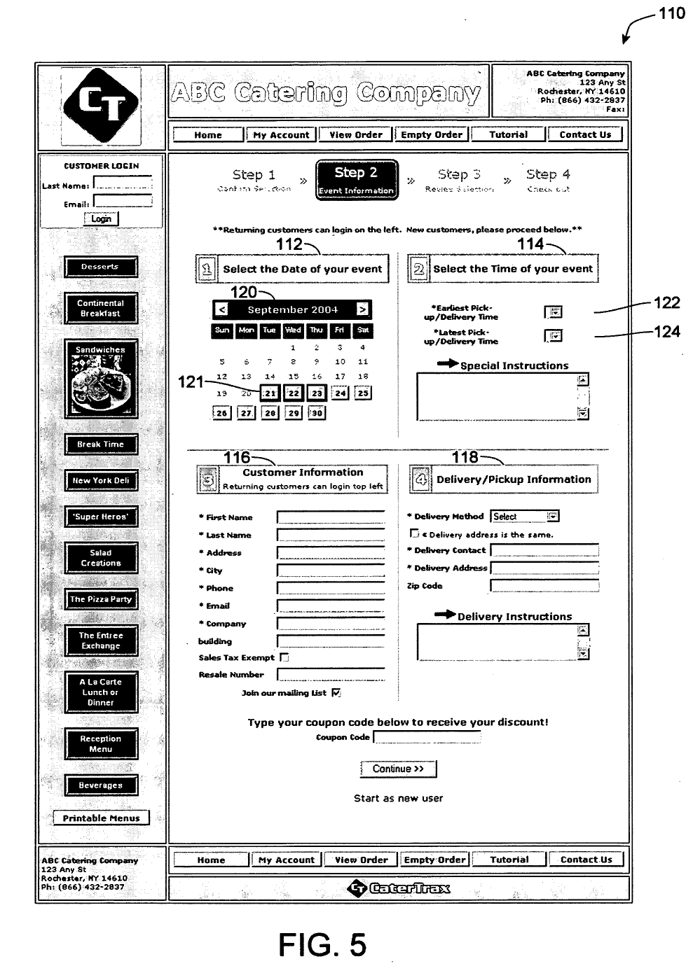

Step 2 in the order completion process appears as page 110 in FIG. 5. The page 110 contains four sections, the “Select the Date of your event” section 112, the “Select the Time of your event” section 114, the “customer Information” section 116, and the “Delivery/Pickup Information” section 118. In the “Select the Date of your event” section 112 is a calendar 120 showing dates following the current date of the order. The food provider may place certain restrictions on certain dates. In FIG. 5 the dates of September 21, 22, and 23 are surrounded by a ring 121 which indicates that food provider cannot guarantee delivery on those dates because the food provider may not have time to prepare the order. In this case, the customer would call the food provider to see if the food provider can have the order ready on one of the ringed dates.

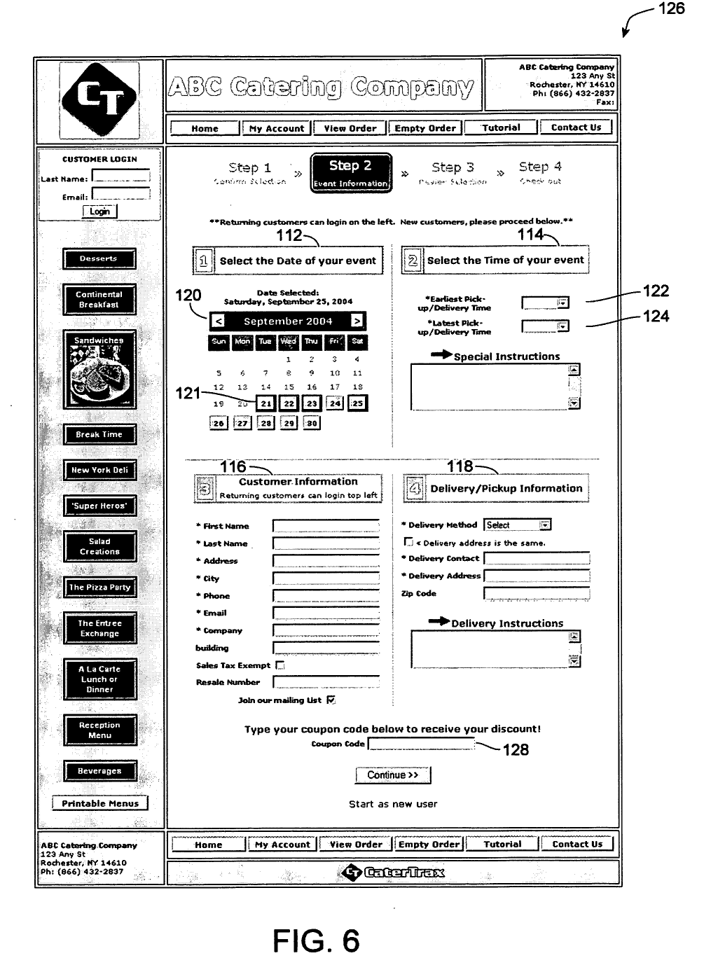

After the customer has selected a date, page 100 is modified as shown on page 126 in FIG. 6. In FIG. 5 the “Select the Time of your event” section 114 had the “*Earliest Pickup/Delivery Time” drop down box 122 and the “*Latest Pickup/Delivery Time” drop down box 124 disabled since the opening and closing hours of the food provider depends on the day of the week. In FIG. 6, once the date has been selected, the customer then selects the time window in which the food is to be picked up or delivered using boxes 122 and 124, respectively. The customer also completes section 116 if the customer has not logged in, and section 118. The customer can take advantage of any coupons received previously by entering a coupon code in the box 128.

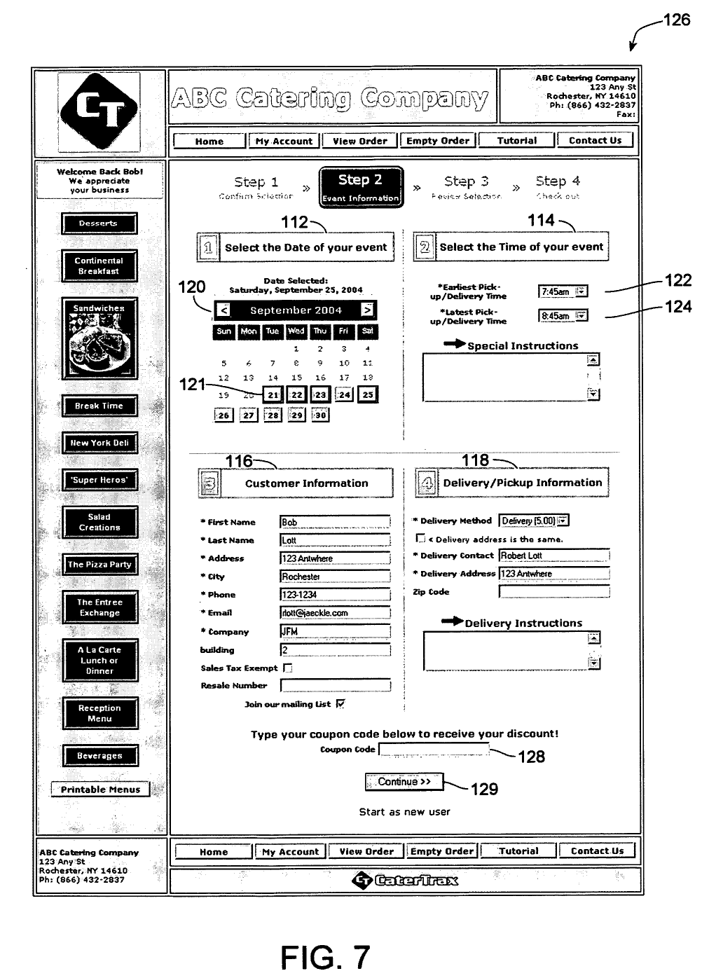

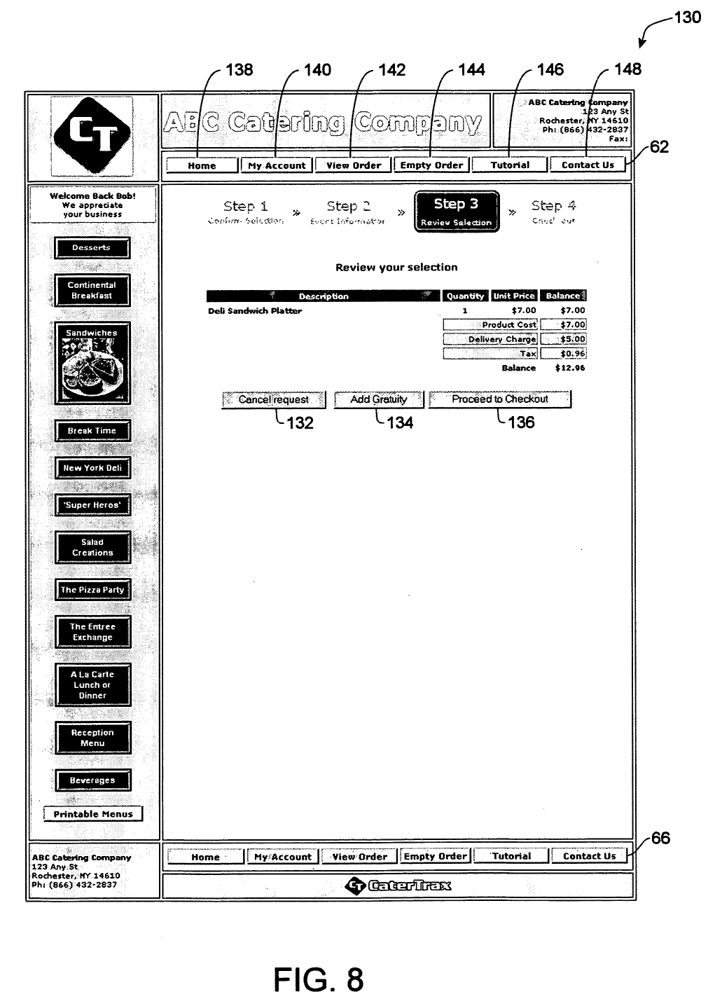

FIG. 7 is FIG. 6 with page 120 completed. The customer then clicks on the “continue” button 129 to move on to step 3 to bring up a new page 130 shown in FIG. 8. Page 130 again summarizes the order to allow the customer to either cancel the order by clicking on the “Cancel request” button 132, to add a gratuity by clicking on the “Add Gratuity” button 134, or to continue to step 4 by clicking on the “Proceed to Checkout” button 136.

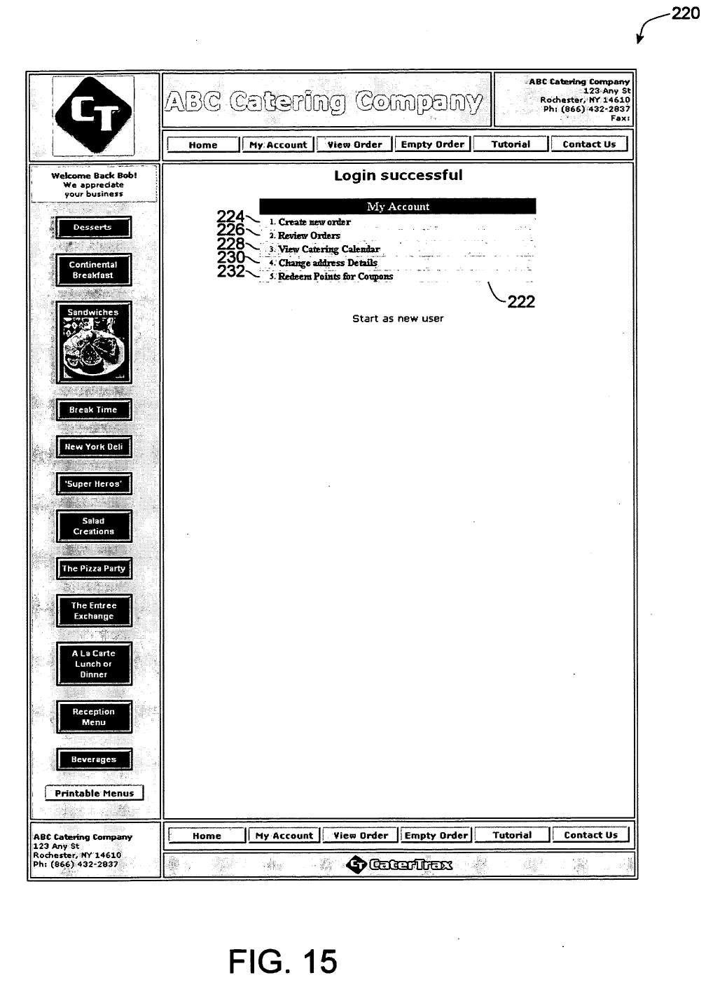

At any time during the ordering process the customer can click on any of the buttons on button rows 62 and 66. The “Home” button 138 allows the customer to begin a new order, the “My Account” button 140 brings up a selection menu described below in the discussion of FIG. 15, the “View Order” button 142 allows the customer to view the order in process, the “Empty Order” button 144, when clicked on, cancels the current order, the “Tutorial” button 146 explains the ordering process, and the “Contact Us” button 148 brings up an email message box for the customer to send an email to the food provider.

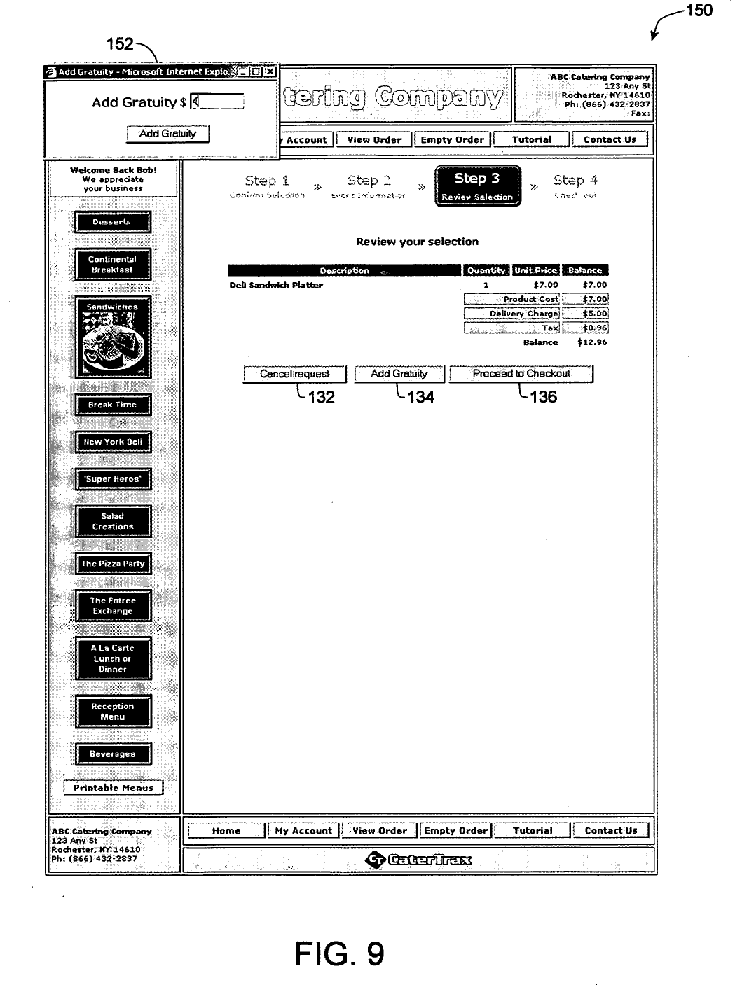

If the customer clicks on the “Add Gratuity” button 134, an add gratuity pop up box 152 appears as shown on the page 150 in FIG. 9.

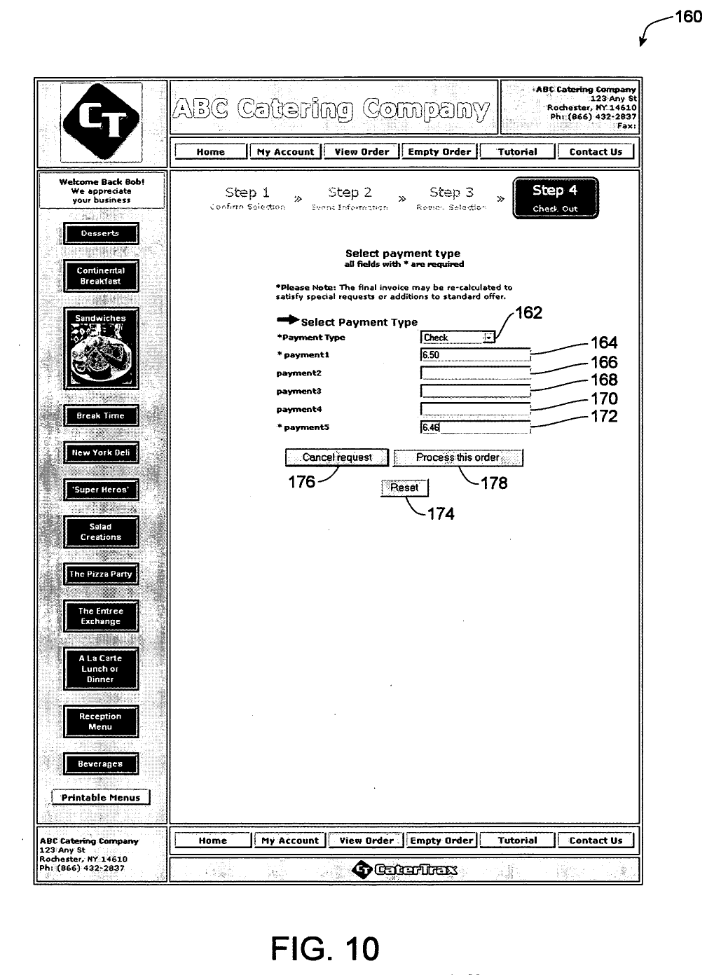

The step 4 page 160 shown in FIG. 10 is the final ordering page. On this page the customer selects the payment type in drop down box 162, and amount of up to five payments which the customer will make in boxes 164, 166, 168, 170, and 172. The customer can then reset the payment data by clicking on the “Reset” button 174, cancel the order by clicking on the “Cancel request” button 176 or complete the order by clicking on the “Process this order” button 178.

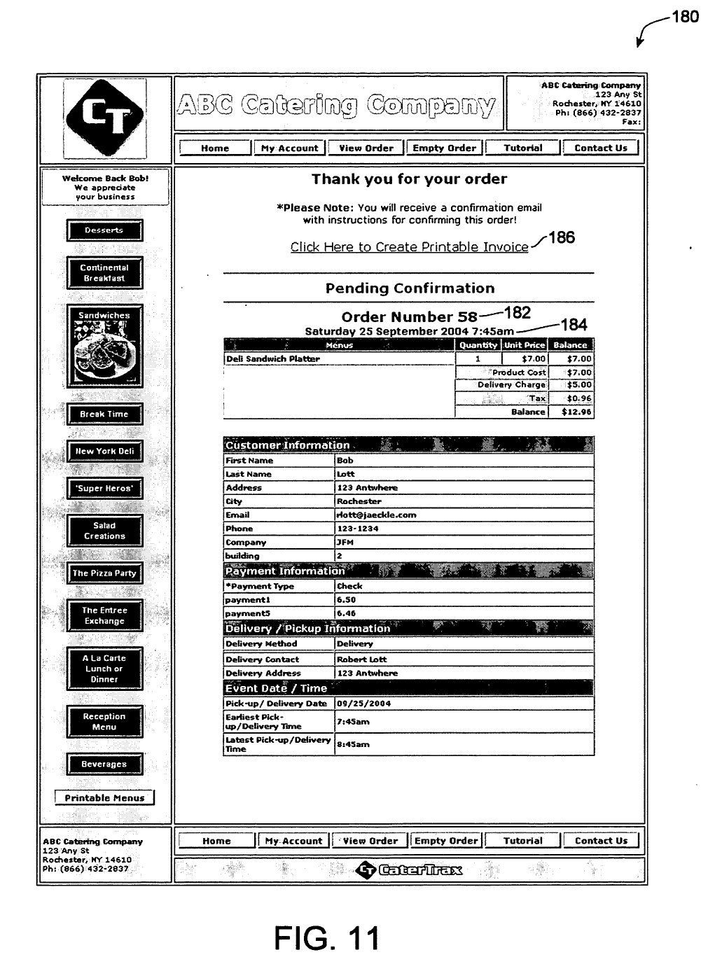

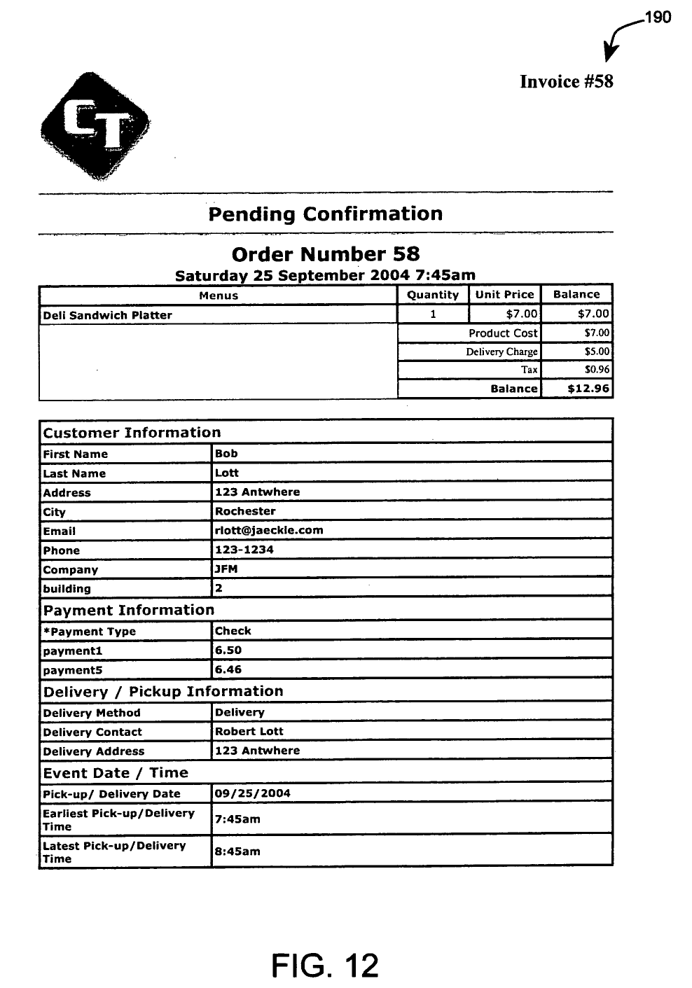

Clicking on the “Process this order” button 178 brings up an order confirmation page 180 shown in FIG. 11. Page 180 shows the completed order information including the number 182 assigned to the order and the date and time 184 the order was completed. A clickable link 186 is provided to print out the invoice. The printed invoice 190 generated by clicking on link 182 is shown in FIG. 12. Both the completed order page 180 and the printed invoice 190 show that the order is pending confirmation, meaning that additional action by the customer is required to confirm the order before the food provider prepares the order.

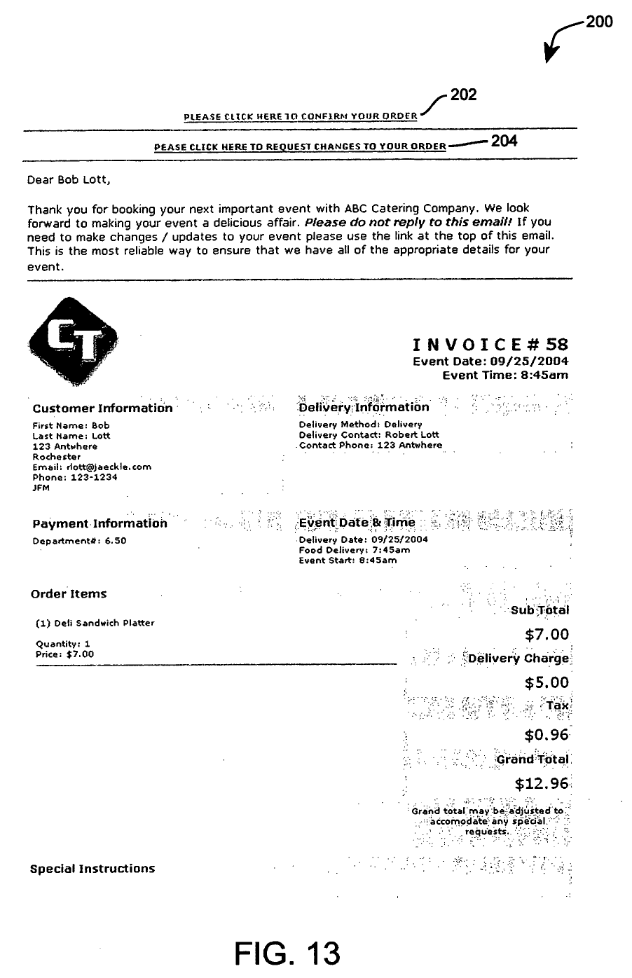

When the “Process this order” button in FIG. 10 is clicked, an email 200 is automatically generated to the customers email address. The email 200, shown in FIG. 13, thanks the customer for the order and summarizes the order. The email also has URL links so that the customer can confirm the order by clicking on link 202, and can change the order by clicking on link 204.

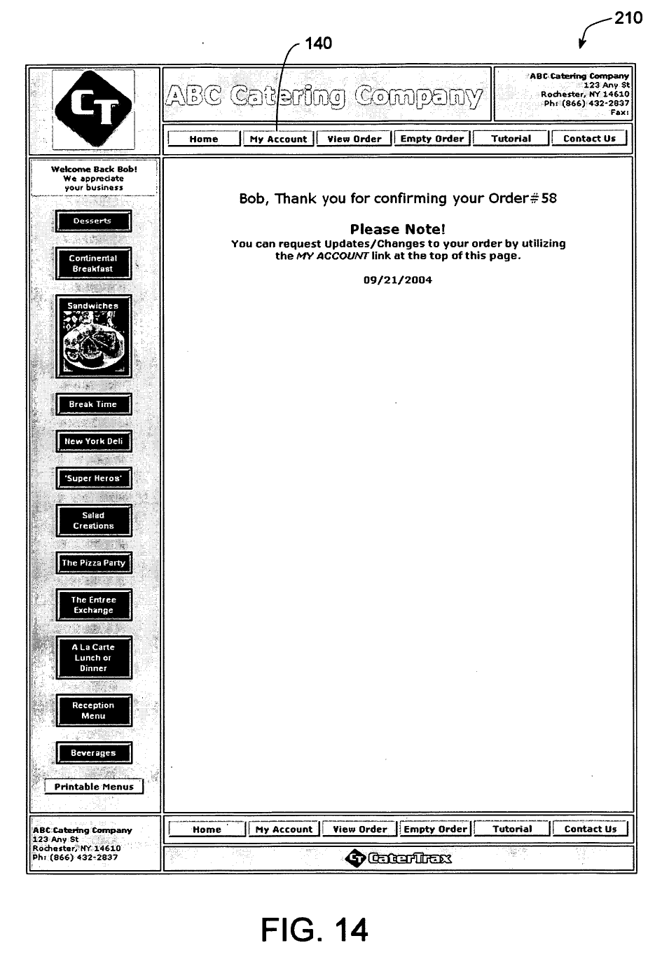

Upon clicking on the confirmation link 202, page 210, shown in FIG. 14 appears thanking the customer for confirming the order. The page 210 also tells the customer that the order can updated or changed by clicking on the “My Account” button 140.

Clicking on the “My Account” button 140 produces page 220 shown in FIG. 15. A list of links 222 is provided to the customer with a first selection 224 to create a new order, a second selection 226 to review a current order, a third selection 228 to view a catering calendar, a fourth selection 230 to change the customer information, and a fifth selection 232 to redeem points for coupons.

Clicking on the first selection 224 brings up the home page 50 of FIG. 1 so that the customer can select additional categories to add to the present order.

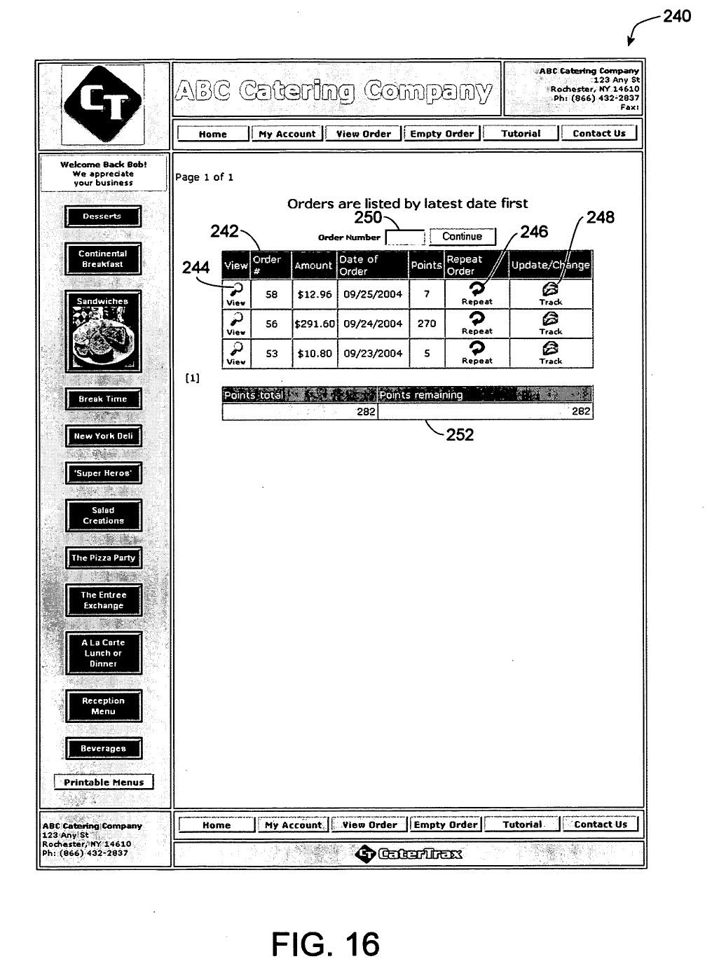

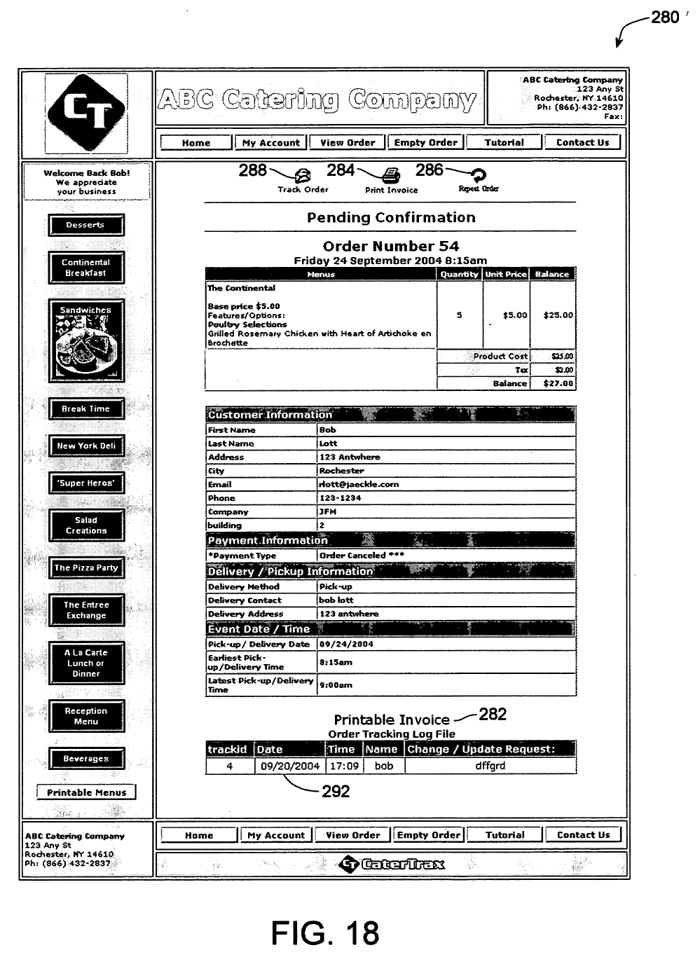

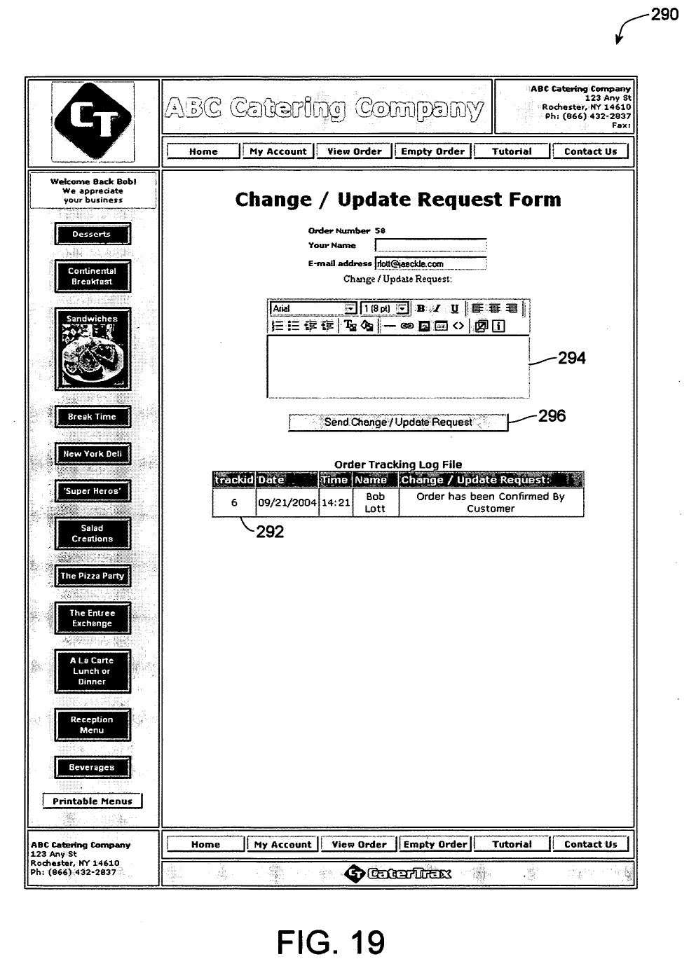

FIG. 16 shows page 240 which appears when button 226 is clicked and lists all of pending orders for a particular customer in a table 242. The customer can get additional information about each order by clicking on a the “view” icon 244 for a particular order which brings up page 280 shown in FIG. 18. The customer can repeat one of the orders by clicking on the “repeat” icon 246 which takes the customer to step 1 on page 100 in FIG. 4. The “track” icon 248 allows the customer to view the order tracking log file 292 shown in FIGS. 18 and 19. Above the table 242 is a box 250 for a customer to enter an order number 182 to view the applicable row of the table 242 for the particular order. Below the table 242 is a row 252 listing the total points that the customer has accumulated and the points that the customer has remaining. The food provider awards points for every order placed as an incentive to its customers to make future orders. The food provider can, if they desire, provide the customer with different options or rewards for which the points are redeemable. As described below, this food provider allows the customer to use the points to obtain coupons having cash values for future orders.

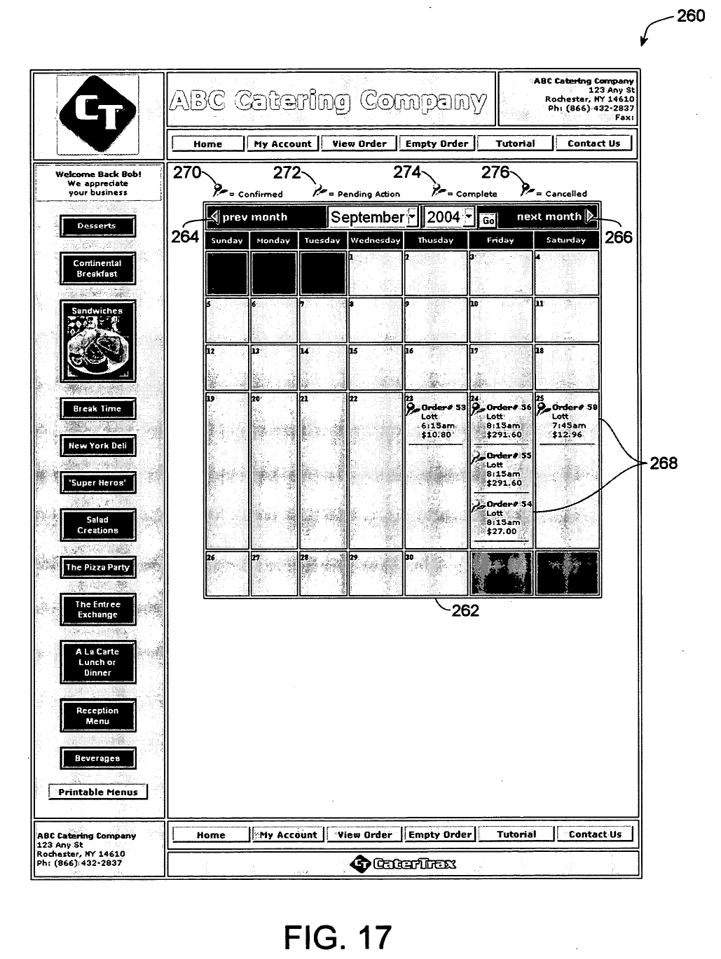

FIG. 17 shows the calendar page 260 when the customer selects to view the catering calendar from the list shown in FIG. 15. The calendar page 260 has a calendar 262 of the current month. Previous months and future months can be selected using the “prev month” 264 and “next month” 266 arrows, respectively, at the top of the calendar 262. As can be seen in FIG. 17, orders placed by the customer are listed on their respective delivery/pickup dates. The calendar notes 268 show the order number, the customer name and the time window when the order is to be delivered or picked up. There is also shown with each calendar note 268 a stick pin which is of a particular color on the web page. The meaning of the color of each pin is shown above the calendar 262 with a green pin 270 indicating that an order has be confirmed, a yellow pin 272 indicating that an order is pending action such as awaiting confirmation, a white pin 274 indicating that an order has been completed, and a red pin 276 indicating that an order has been cancelled.

Clicking on one of the orders 268 on the calendar 262, for example order 54, brings up page 280 shown in FIG. 18. Page 280 gives the order information including the food products ordered, the customer information, the payment information, the delivery information, the date and time of the event, and the order tracking log file. Clicking on link 282 labeled “Printable Invoice” just above the order tracking log file, or icon 284 labeled “print Invoice” near the top of the page prints the page shown in FIG. 12. Clicking on the “Repeat Order” icon 286 pulls up the “Step 1” page 100 in FIG. 4. Finally, clicking on the “Track Order” icon 288 brings up page 290 shown in FIG. 19.

Page 290 in FIG. 19 shows the current order tracking log file 292 and also provides a text entry window 294. To change an order or request a change to an order, as appropriate, a customer can type the change or request in text entry window 294 and click the “Send Change/Update Request” button 296.

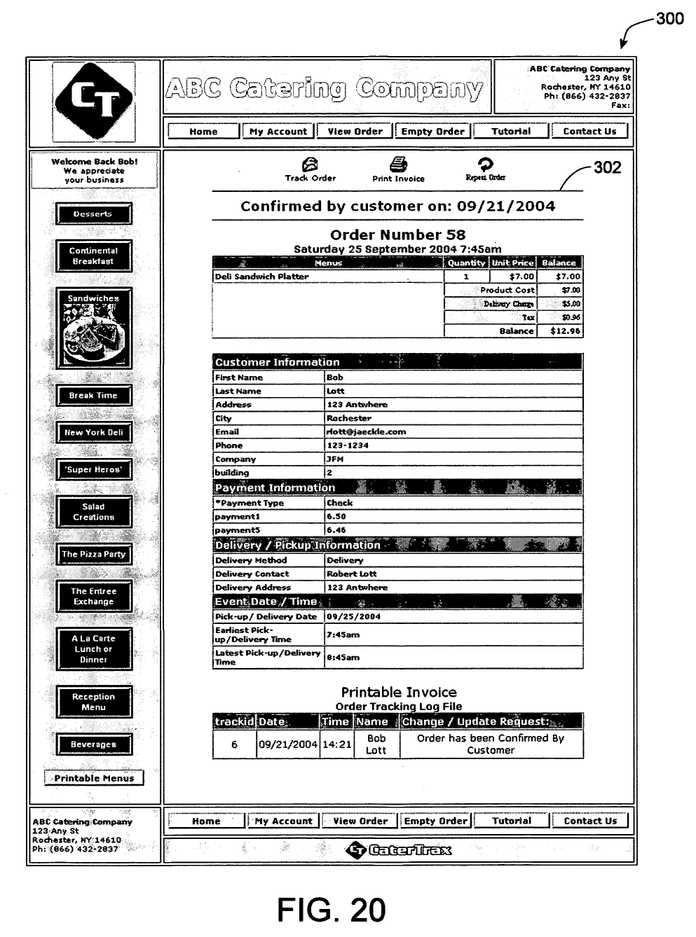

FIG. 20 shows page 300 which appears when order number 58 is selected in the calendar 268 shown in FIG. 17. Page 300 provides the same type of information as page 280 of FIG. 18 except that text 302 above the detail order information states that the order was confirmed and the confirmation date.

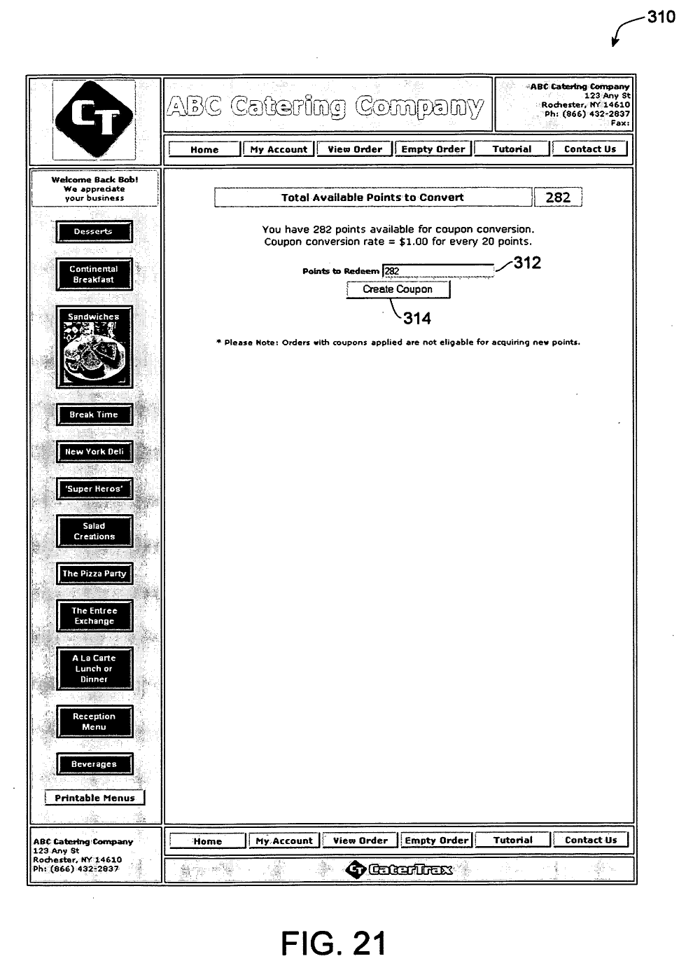

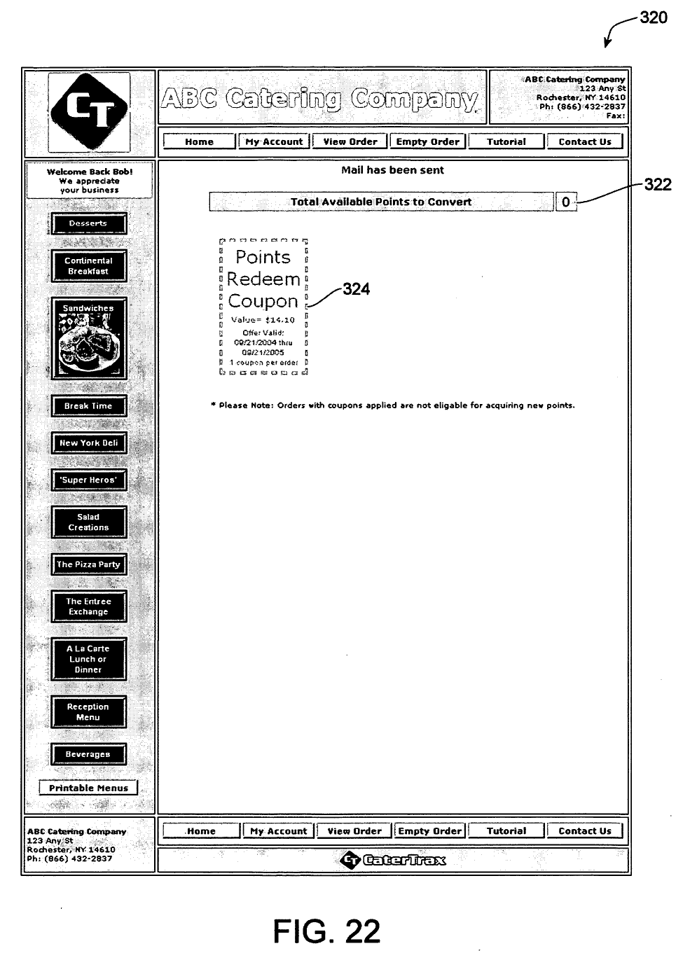

FIG. 21 shows page 310 which appears when the fifth category 232 entitled “Redeem Points for Coupons” in FIG. 15 is clicked on. Page 310 shows the number of points available for redemption and provides a data entry window 312 for the customer to select the number of points to redeem. After the customer selects the number of points to redeem and clicks on the “Create Coupon” button 314 page 320 shown in FIG. 22 is brought up.

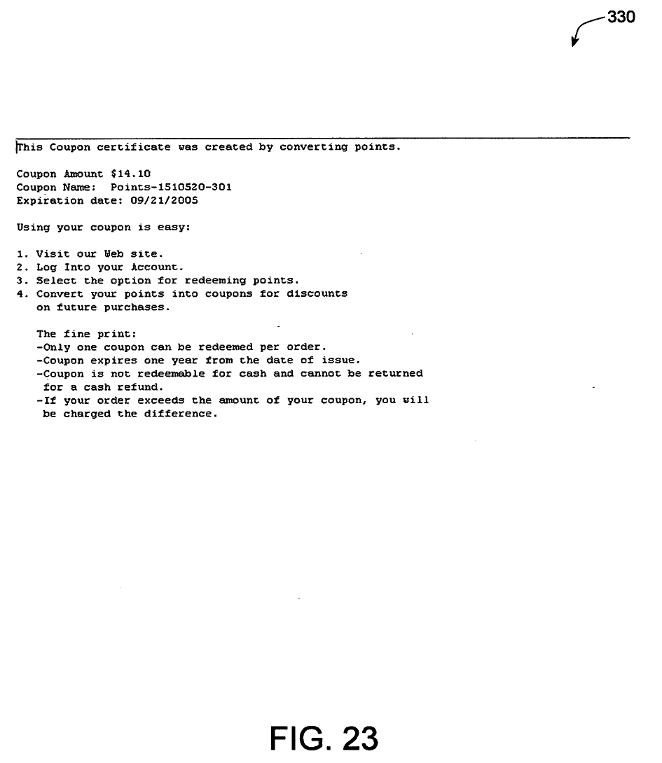

Page 320 provides the number of points left to redeem in box 322 and a coupon 324 showing the value of the coupon. When the customer clicks on the coupon 324, the discount is applied to a customer's future order. Also, when the “Create Coupon” button 314 is clicked on, an email 330 shown in FIG. 23 is sent to the customer. The email provides instructions to the customer on how to use the coupon.

In addition to the advantages described above, by automating the order intake system as described herein, caterers can automatically generate the forms needed by the kitchen staff and others so that mistakes in fulfilling customer orders are minimized and time normally used to transfer customer data is saved. Further, forms generated for the kitchen, need not be in the traditional form, but a single form can be created which shows the kitchen staff everything that needs to be prepared for a single day rather than the kitchen staff having to look at a separate form for each customer who is expecting to receive his order that day.

Not only can embodiments of the invention be used by caterers who offer their services to the general public, but embodiments of the invention are also useful to institutions such as universities and corporations that have services for caterering internal gatherings and events.

The embodiment described has been chosen to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

Although the present invention has been described in considerable detail with reference to certain preferred versions thereof, other versions are possible. For example, a delivery or pick up date may be selected from a menu, other than the calendar as shown, or typed in by the customer.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

I claim:

1. A method for catering comprising:
displaying a web page on a client computer, the web page offering a plurality of prepared food selections; and
receiving input from the client indicating at least on food selection and a future date for desired pick up or delivery of the food selection.

2. The method of claim 1 further comprising:
displaying a web page offering a plurality of future dates on which the food selection can be delivered to or picked up by the client.

3. The method of claim 2 further comprising receiving a second input from the client indicating a second food selection and a second future date for desired delivery or pick up of the food selection.

4. The method of claim 1 further comprising displaying a calendar with at least two sets of distinguishable dates, a first set of dates on which the client is able to receive via delivery or pick up any of the plurality of prepared food selections and a second set of dates on which the client is able to receive via delivery or pick up a subset of the plurality of prepared food selections.

5. The method of claim 1 wherein the web page is customized for a particular caterer.

6. The method of claim 1 wherein at least a portion of the input from the client is automatically placed on a report.

7. The method of claim 1 wherein the client previously placed an order via the web page further comprising displaying the previously placed order.

8. The method of claim 1 further comprising sending an e-mail to the client confirming the input received from the client.

9. The method of claim 1 wherein the client previously placed an order via the web page further comprising receiving input from the client indicating that the client would like to repeat the previously placed order.

10. The method of claim 1 further comprising giving the client an incentive to make future orders by offering an automatically generated electronic coupon the value of which is at least partially based on a client's previous order.

11. A web based prepared food provider site for processing a food order comprising:
a page with a first plurality of links for selecting one of a plurality of food items, each link associated with a food item;
an area for selecting the quantity of the food item, wherein when one of the food items is selected, it becomes an ordered food item;
an order summary page produced when one of the links associated with a food item is activated; said order summary page showing the ordered food item, quantity and price for the ordered food item, the order summary page additionally having a link for processing the food order;
an order processing page appearing when the link for processing the food order is activated, the order processing page containing an area for inputing a date for providing the ordered food item; and
a payment page for selecting payment options.

12. The site of claim 11 further comprising a calendar with at least two sets of distinguishable dates, a first set of dates on which any of the food items can be provided and a second set of dates on which a subset of the food items can be provided.

13. The site of claim 11 wherein the site is customized for a particular caterer.

14. The site of claim 11 further comprising a page displaying previously ordered food items.

15. The site of claim 11 further comprising a page for registered users of the site to log in.

16. The site of claim 11 further comprising an automatically generated electronic coupon, the value of which is at least partially based on a previous order.

17. A web based food provider site for processing a food order comprising:
a home page with a first plurality of link icons representing food categories for selecting one of said first plurality of link icons;
said site showing a second plurality of subcategories when one of said first plurality of link icons is selected, each of said subcategories having one or more separate food item identifiers;
each of said food item identifiers having an area for selecting the quantity of said food item, an area for text entry, and a link icon for selecting said food item;
an order summary page produced when said link icon for selecting said food item is activated; said order summary page showing food items, quantities and prices for food items that have been selected, said order summary page additionally having a link icon for continuing with said food order;
an order processing page appearing when said link icon for continuing with said food order is activated, said order processing page containing a calendar for selecting a date of providing said food order by said food provider and drop down windows for selecting an earliest time for food order to be provided and a latest time for said food order to be provided; and
a payment page for selecting payment options after said date has been selected.

18. A method of processing a food order comprising the steps of:
reaching a home page of a food provider web site, said home page having a first plurality of food categories;
selecting one of said food categories on said home page;
selecting a food item in said food category on a second page of said web site;
entering a quantity of said food item and entering a textual request concerning said food item on said second page;
providing a date for said food order to be available on a third page of said web site;
providing payment information on a fourth page of said web site; and
clicking on a confirmation link in an email sent by said food provider to confirm said food order.
